(19) United States
(12) Patent Application Publication
(10) Pub. No.: US 2002/0119436 A1
(43) Pub. Date: Aug. 29, 2002

(54) Imaging rotation cup

(76) Inventor: Hsieh-Tsung Yeh, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/793,614

(22) Filed: Feb. 27, 2001

(51) Int. Cl. G09B 25/00

(52) U.S. Cl. 434/365

(57) ABSTRACT

An imaging rotation cup comprises a cup body and an outer shell, wherein the cup body comprises a drawing having at least two pictures on its surface. Each picture of the drawing is formed with parallel and equal spaced lines. The outer shell on the cup body is made of nontransparent material with a transparent portion which is able to disclose the pictures. The transparent portion of the outer shell comprises transparent sections corresponding to the parallel spaced lines of the pictures, individually. Whereas the transparent portion allows the picture to be shown while the transparent portion laps the corresponding picture.

### BACKGROUND OF THE INVENTION

1. Field of the Invention

This invention relates to an imaging rotation cup, and more particularly to drawings on the cup that can be blocked or seen by rotating an outer shelf of the cup.

2. Description of Prior Arts

Cups with one or more drawings to display on the cup, especially the drawings can be shown by overlap or cross exchange, are disclosed on U.S. Pat. Nos. 4,033,059, 4,040,353, 4,263,737, and U.S. Pat. Nos. 5,098,302, 5,100,330 5,197,886, 5,364,274, 5,494,445, 5,695,346 by Sekiguchi. All of these patents are in related to change pictures of a cup by using a transparent outer shell with a high-low uneven surface, however, this design requires viewers to view the pictures from a special angle. Among the above patents, only U.S. Pat. Nos. 5,494,445 and 5,695,346 discloses the rotation of the outer shell to view pictures. U.S. Pat. No. 5,695,346 teaches vertical lines net covers the cup, so that viewers may view the pictures from different angles. U.S. Pat. No. 5,494,445 is also identical to the above prior patent.

From the above we find out the following shortcomings:

1. The outer shell or net is thicker.

2. In order to view pictures, viewers have to change their position or to find the appropriate angle.

3. During changing position or searching angle, viewers may see an incomplete picture.

### SUMMARY OF THE INVENTION

It is the primary object of the present invention to provide an imaging rotation cup, which can change the pictures by rotation of an outer shell without changing a viewer's angle.

It is another object of the present invention to provide an imaging rotation cup, which is easy to operate and to provide an accurate picture.

It is a further object of the present invention to provide an imaging rotation cup, which is inexpensive in manufacture.

### BRIEF DESCRIPTION OF THE DRAWINGS

FIG. 1 is an exploded view of the present invention;

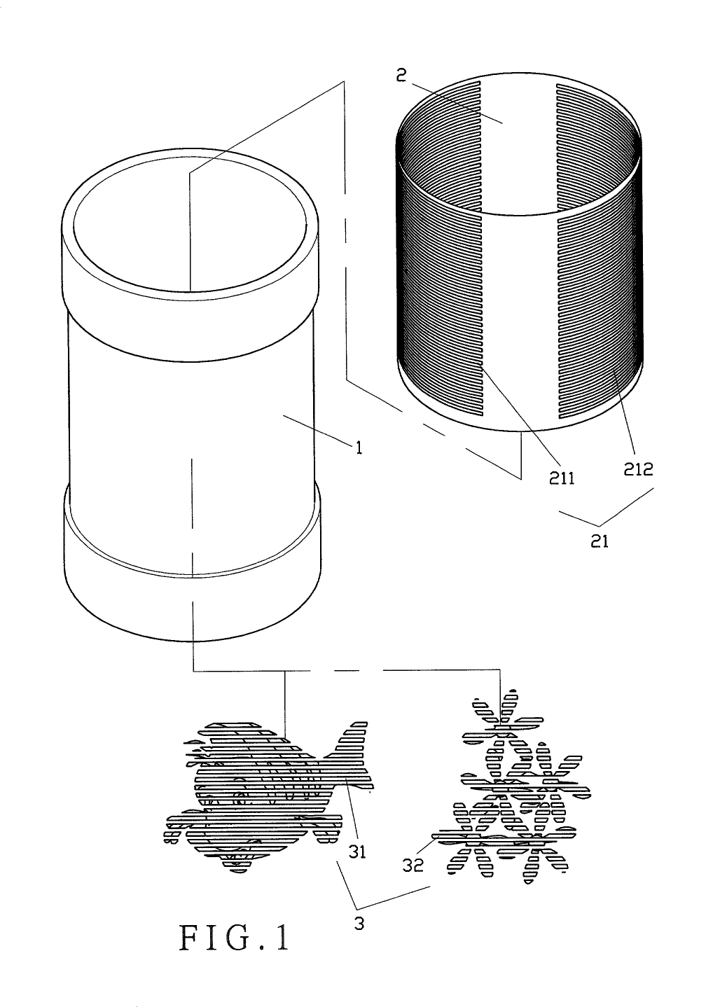

FIG. 2 is a side view with a picture showing on the body of the cup;

FIG. 3 is a side view of a first embodiment of the present invention; and

FIG. 4 is a side view of a second embodiment of the present invention.

### DETAILED DESCRIPTION OF THE PREFERRED EMBODIMENTS

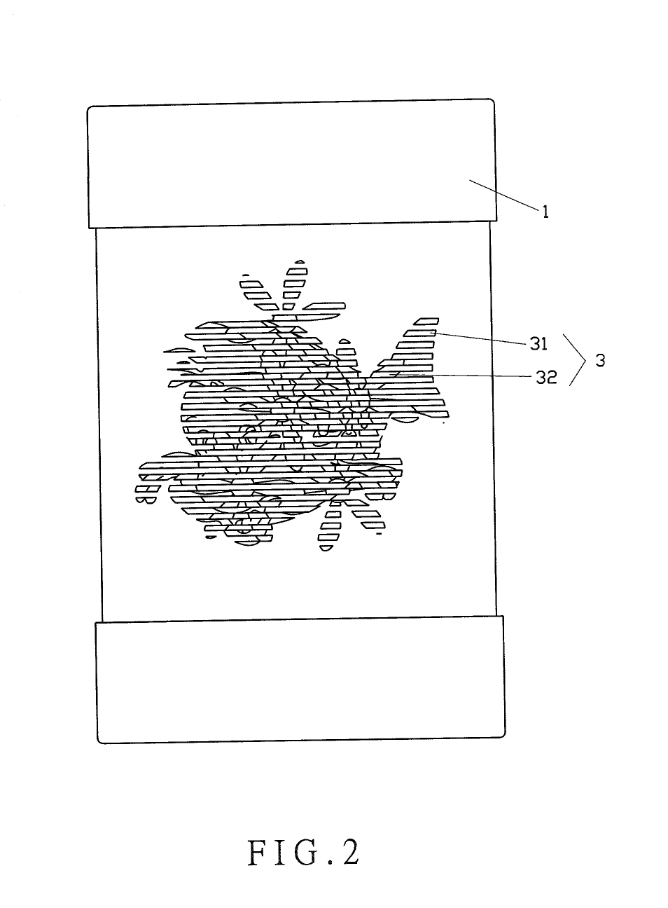

The present invention comprises a cup body 1 and an outer shell 2. The cup body 1 has a drawing 3 on its outer surface. The drawing 3 is constructed of two or more pictures 31 and 32. The outer shell 2 covers outside of the cup body 1. The outer shell 2 is made of nontransparent material with a transparent portion 21 which is able to disclose the picture 31 or 32. The pictures 31 and 32 are both cut into parallel lines which are equally spaced from each other, as shown in FIG. 2. The transparent portion 21 of the outer shell 2 comprises a first transparent section 211, and a second transparent section 212 and the transparent sections are corresponding to the spaced lines of the pictures 31 or 32, individually.

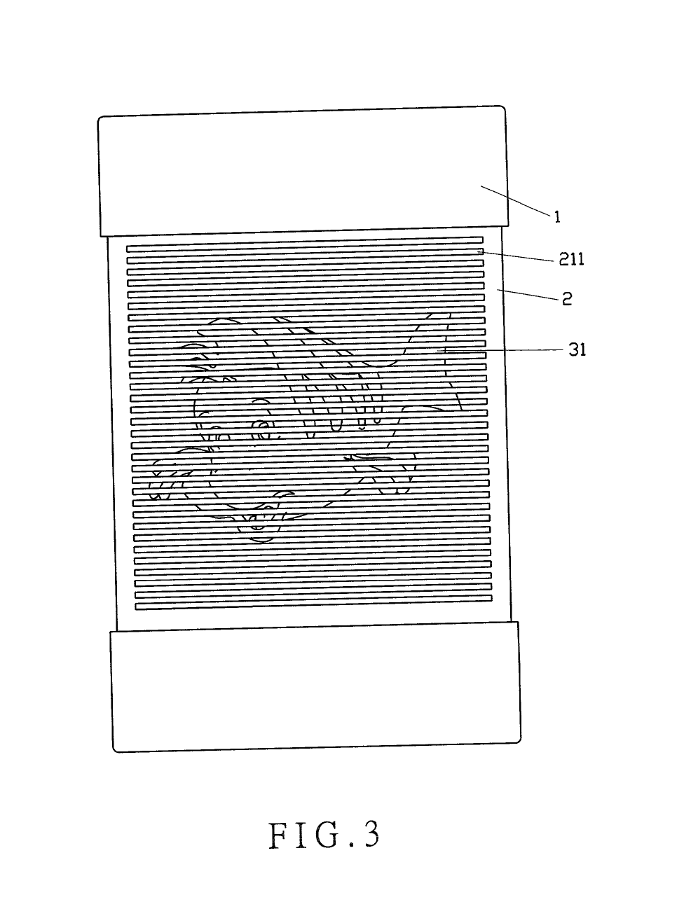

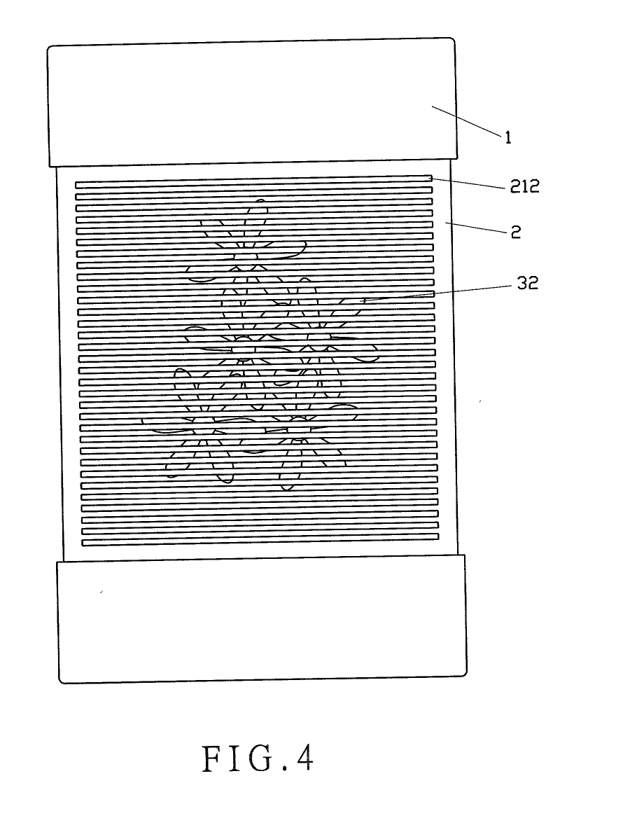

As shown in FIG. 3, the outer shell 2 sleeves on the cup body 1 and the drawing 3 are in line with the transparent section 21 of the outer shell 2. Upon the first transparent section 211 of the transparent portion 21 laps with the picture 31 of the drawing 3, the picture 31 can be seen. By rotating the outer shell 2, the second transparent section 212 of the transparent portion 21 laps with the picture 32 of the drawing 3, the picture 32 can be seen, as shown in FIG. 4. Thus, it is not necessary for viewers to change viewer's angle.

I claim:

1. An imaging rotation cup comprising a cup body and an outer shell covering said cup body, wherein said cup body comprising a drawing on its surface, said drawing being constructed of two or more pictures, said outer shell being made of nontransparent material with a transparent portion thereon to disclosure said pictures of said drawing, and the improvements comprising:
said pictures of said drawing being formed by parallel lines spaced from each other equally, said transparent portion of said outer shell comprising transparent sections, said transparent sections corresponding to the parallel lines of said pictures, individually, thus upon said transparent section of said transparent portion of said outer shell laps the parallel lines of said corresponding picture, individually, said picture can be seen

2. The imaging rotation cup, as recited in claim 1, wherein said picture is formed by numerous parallel and equal spaced lines.
